(19) United States
(12) Patent Application Publication
(10) Pub. No.: US 2026/0309214 A1
(43) Pub. Date: Oct. 8, 2026

(54) HELICAL GEAR LIMITED SLIP DIFFERENTIAL WITH WASHER CLUTCH PLATES

(71) Applicant: Schaeffler Technologies AG & Co. KG, Herzogenaurach (DE)

(72) Inventor: Jordan Geiser, Massillon, OH (US)

(73) Assignee: Schaeffler Technologies AG & Co. KG, Herzogenaurach (DE)

(21) Appl. No.: 19/098,093

(22) Filed: Apr. 2, 2025

(51) Int. Cl. F16H 48/22

(52) U.S. Cl. CPC F16H 48/22; F16H 48/10; F16H 48/285

(57) ABSTRACT

A limited slip differential including a differential gear case, first and second side gears, and one or more washer clutch plates. During operation of the limited slip differential under differential output when the side gears are rotating relative to each other friction between the one or more washer clutch plates and adjacent structure occurs affecting the torque bias ratio of the limited slip differential. Various configurations of inboard and outboard washer clutch plates can be used to achieve different torque bias ratios in the forward and reverse directions.

### TECHNICAL FIELD

The present disclosure relates generally to differentials for vehicle drive trains, and more specifically to limited slip differentials.

### BACKGROUND

In general, limited slip differential (LSD) are known structures used in motor vehicle for transmitting torque to the drive wheels.

LSDs are beneficial for some applications because they allow torque to be distributed to where it is needed. LSDs can compensate for reduced traction in one wheel by distributing the majority of the torque to the wheel with higher traction. The ratio of the torque to the high traction wheel divided by the torque to the low traction wheel is the torque bias ratio (TBR). The TBR in a helical gear style mechanical LSD is created by the axial and radial reaction forces from the helical gears increasing internal friction. Although these reaction forces are necessary for the TBR, it is also desirable to keep them as low as possible or reduce them while also maintaining the proper TBR. Reduced reaction forces allows the differential components to be smaller, fasteners to be smaller, and makes the gears, housing and cover more robust against wear from rotating contact.

The torque bias ratio (TBR) of a mechanical limited slip differential is determined by the internal friction created by the interaction of all of the components. The TBR is an important design parameter as it controls the amount of torque supplied to each wheel during a low-traction event.

### SUMMARY

In accordance with one aspect, a limited slip differential comprises a differential gear case, first and second side gears supported for rotation relative to the differential gear case, and a first washer clutch plate fixed to the first side gear. During operation of the limited slip differential under differential output when the side gears are rotating relative to each other, the first washer clutch plate engages adjacent structure of the differential creating frictional drag.

The first washer clutch plate can be splined to the first side gear. The first washer clutch plate can be an outboard washer clutch and the adjacent structure of the differential can be the gear case. The differential can include second and third washer clutch plates, and the second and third washer clutch plates can be inboard washer clutch plates each fixed to a respective one of the first and second side gears such that during operation of the differential under differential output when the side gears are rotating relative to each other the second and third washer clutch plates engage each other creating frictional drag. The differential can include a fourth washer clutch plate fixed to the second side gear, and the fourth washer clutch plate, during operation of the limited slip differential under differential output when the side gears are rotating relative to each other, can engage adjacent structure of the differential creating frictional drag. The second and third washer clutch plates can engage each other primarily during forward operation of the differential due to reaction torque forcing the side gears towards each other, and the first and third washer clutch plates can engage the differential gear case primarily during reverse operation of the differential due to reaction torque forcing the side gears away from each other. The differential can include a plurality of pinion gears meshed to radially outer sides of the side gears. The side gears can include splines for rotationally coupling to respective axle shafts. The side gears and the at least one washer clutch plate can be supported by the differential gear case for limited axial movement relative to each other. The limited slip differential can be a helical gear type limited slip differential.

In accordance with another aspect, a limited slip differential comprises a differential gear case, first and second side gears supported for rotation relative to the differential gear case, a first washer clutch plate fixed to the first side gear, and a second washer clutch plate fixed to the differential gear case. During operation of the limited slip differential under differential output when the side gears are rotating relative to the differential gear case, the first washer clutch plate engages the second washer plate creating frictional drag.

The first washer clutch plate can be an inboard washer clutch plate splined to an axially inner side of the first side gear and the second washer plate can be an inboard washer plate splined to the differential gear case. The first washer clutch plate can be an outboard washer clutch plate splined to an axially outer side of the first side gear and the second washer plate can be an outboard washer plate splined to the differential gear case. The differential can further include a plurality of inboard washer plates between the first and second side gears, wherein the inboard washer clutch plates include at least one washer clutch plate fixed to one of the side gears and at least one washer plate fixed to the differential gear case, wherein, during operation of the differential under differential output when the side gears are rotating relative to each other, the inboard washer clutch plates engage each other creating frictional drag. The inboard washer clutch plates can engage each other primarily during forward operation of the differential due to reaction torque forcing the side gears towards each other, and the outboard clutch plates can engage each other primarily during reverse operation of the differential due to reaction torque forcing the side gears away from each other. The differential can further include a plurality of pinion gears meshed to radially outer sides of the side gears. The side gears can include splines for rotationally coupling to respective axle shafts. The side gears can be supported by the differential gear case for limited axial movement relative to each other. The differential can be a helical gear type limited slip differential.

In accordance with another aspect, a limited slip differential comprises a differential gear case, first and second side gears supported for rotation relative to the differential gear case, a plurality of pinion gears meshed to radially outer sides of the side gears, two pairs of outboard washer clutch plates, each pair of outboard washer clutch plates on a respective axially outer side of a respective side gear and including a first washer clutch plate fixed to the respective side gear and a second washer clutch plate fixed to the differential gear housing, and two pairs of inboard washer clutch plates, each pair of inboard washer clutch plates including a first washer clutch plated fixed to a respective axially inner side of a respective side gear and a second washer clutch plate fixed to the differential gear housing. The inboard washer clutch plates can engage each other primarily during forward operation of the differential due to reaction torque forcing the side gears towards each other, and the outboard clutch plates engage each other primarily during reverse operation of the differential due to reaction torque forcing the side gears away from each other.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of an conventional limited slip differentia.

FIG. 2 is a cross-sectional view of an exemplary limited slip differential in accordance with the present disclosure

FIG. 3 is an axial end view the exemplary limited slip differential in accordance with the present disclosure.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

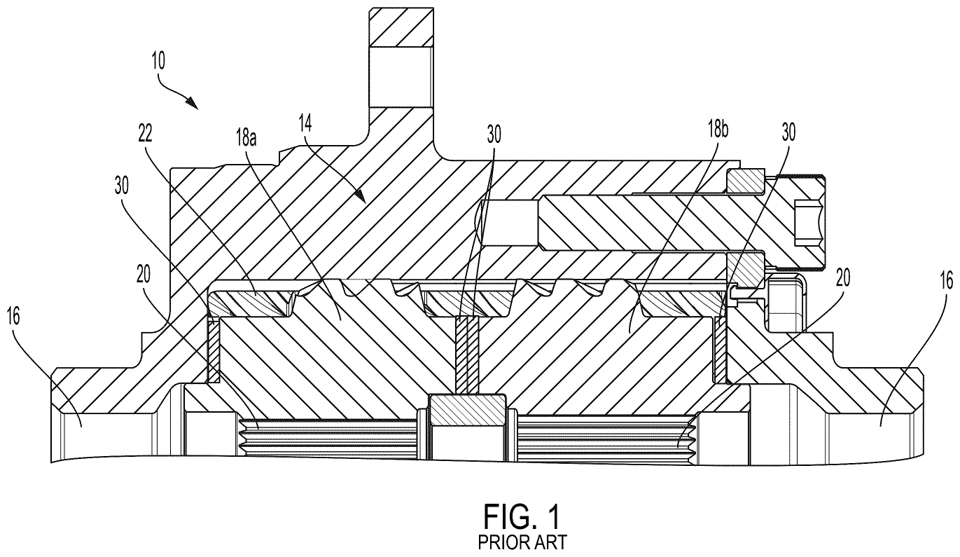

Referring to FIG. 1, an exemplary prior art helical gear type limited slip differential (LSD) is illustrated and identified generally by reference numeral 10. The LSD includes a differential gear case 14 integrally connected to a ring gear (not shown) rotated by power output from a transmission, axle shafts (not shown) are inserted into openings 16 in both sides of the differential gear case 14 and coupled for rotation with a respective side gear 18a/18b. The side gears include splines 20 adapted to engage corresponding splines of the axle shafts. A plurality of pinion gears 22 are meshed to the radially outer sides of the side gears 18a/18b and supported at an inner side of the differential gear case 14 for maintaining a parallel position with the rotational axis of the side gears 18a/18b.

The helical gear type LSD operates to perform a differential operation according to resistance applied to wheels connected to the drive shafts and uses frictional force applied between the pinion gears 22 and the differential gear case 14 to restrain the differential operation.

When the resistance transmitted through the drive shafts from both wheels is equal, such as when the vehicle is travelling in a straight path, the differential gear case 14 and the side gears 18a/18b are integrally rotated and both axle shafts splined to the side gears 18a/18b are rotated at the same speed. When the vehicle is turned, the inner wheels have a larger resistance than that of the outer wheels, thereby causing the pinion gears 22 inside the differential gear case 14 to revolve and simultaneously rotate on their axes such that power is transmitted to the outside wheels and the outside wheels are made to rotate at a speed faster than that of the inside wheels.

Washers 30 are assembled between the differential gear case 14 and side gear 18a (outboard washer clutch plate), between side gear 18a and side gear 18b (inboard washer clutch plate), and between side gear 18b and the differential gear case 14 (outboard washer clutch plate). The washers 30 are not splined to the side gears 18a/18b or differential gear case 14 and are free to rotate relative to the side gears 18a/18b and/or differential gear case 14 depending on frictional forces present during operation of the LSD 10. The washers 30 generally improve durability of the LSD 10.

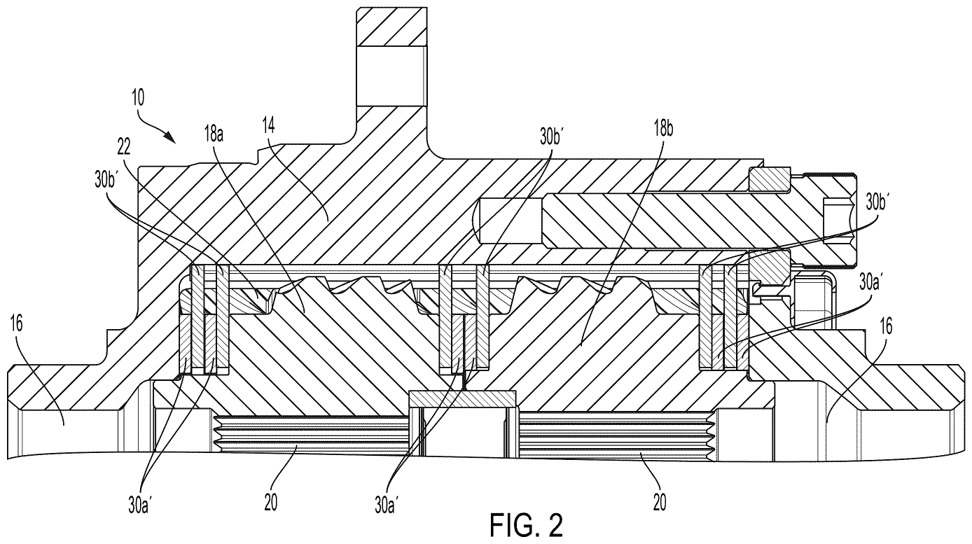

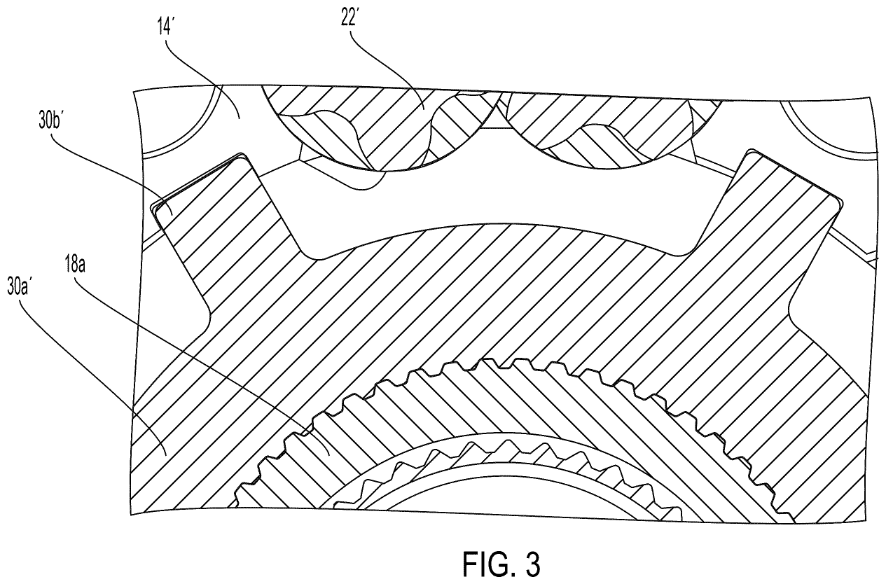

Turning to FIGS. 2 and 3, an exemplary LSD 10′ in accordance with the present disclosure is illustrated and identified generally by reference numeral 10′. The LSD 10′ includes a differential gear case 14′ integrally connected to a ring gear rotated by power output from a transmission, axle shafts (not shown) are inserted into openings 16′ in both sides of the differential gear case 14′ and coupled for rotation with a respective side gear 18a′/18b′. The side gears 18a′/18b′ include splines 20′ adapted to engage corresponding splines of the axle shafts. A plurality of pinion gears 22′ are meshed to the radially outer sides of the side gears 18a′/18b′ and supported at an inner side of the differential gear case 14′ for maintaining a parallel position with the rotational axis of the side gears 18a′/18b′.

In accordance with the present disclosure, the LSD 10′ includes two outboard washer clutch plates 30a′ splined to each of the side gears 18a′/18b′ interleaved between two washer clutch plates 30b′ splined to the differential gear case 14′ on each outboard side of the side gears 18a′/18b′. At the inboard location, a washer clutch plate 30a′ is splined to each side gear 18a′/18b′, and respective washer clutch plates 30b′ are splined to the differential gear case 14′ adjacent thereto. It will be appreciated that the term outboard washer clutch plate refers to a washer clutch plate on an axially outer side of a side gear and the term inboard washer clutch plate refers to a washer clutch plate between the side gears.

Operation of the differential 10′ determines which washer clutch plates 30a′/30b′ (e.g., inboard or outboard washer clutch plates) will be active depending on the helix direction of the gears and the torque direction. In this regard, the active washer clutch plates 30a′30b′ will be automatically compressed by the axial reaction forces from the helical gears.

In the illustrated exemplary embodiment, the side gears 18a/18b are pushed inward in the forward torque direction, so the inboard washer clutch plates 30a′/30b′ between side gears 18a and 18b are active and increasing friction under forward torque. In the reverse torque direction, the outboard washer clutch plates 30a′/30b′ are active and increasing friction. In this way, it will be appreciated that the TBR of the LSD 10′ can be modified with different arrangements of washer clutch plates 30a′/30b′.

It will be appreciated that the exemplary LSD 10′ of FIGS. 2 and 3 can be configured such that the side gears are pushed outward during forward torque and inward during reverse torque without departing from the scope of the present disclosure. In addition, various configurations of washer clutch plates 30a′/30b′ can be used to provide different effects. For example, it is not only possible to achieve a higher TBR in the forward direction than in the reverse direction, but also possible to achieve a higher TBR when the right side axle/side gear is overrunning the left side axle/side gear, or vice versa.

In some embodiments, the washer clutch plates can be made of steel that has been ferrite nitrocarburized for improved durability and wear resistance. Other coatings or heat treatments can be used, such as electroless nickel plating.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 limited slip differential
14 differential gear case
16 openings
18a side gear
18b side gear
20 splines
22 pinion gear
30 washer
30a′ washer clutch plate (fixed to side gear)
30b′ washer clutch plate (fixed to gear case)

What is claimed is:

1. A limited slip differential comprising:
a differential gear case;
first and second side gears supported for rotation relative to the differential gear case; and
a first washer clutch plate fixed to the first side gear for rotation therewith;
wherein, during operation of the limited slip differential under differential output when the side gears are rotating relative to each other, the first washer clutch plate is forced against adjacent structure of the differential creating frictional drag.

2. The differential as set forth in claim 1, wherein the first washer clutch plate is splined to the first side gear.

3. The differential as set forth in claim 1, wherein the first washer clutch plate is an outboard washer clutch and the adjacent structure of the differential is the gear case.

4. The differential as set forth in claim 3, further comprising second and third washer clutch plates, wherein the second and third washer clutch plates are inboard washer clutch plates each fixed to a respective one of the first and second side gears, wherein, during operation of the differential under differential output when the side gears are rotating relative to each other, the second and third washer clutch plates are forced against each other creating frictional drag.

5. The differential as set forth in claim 4, further comprising a fourth washer clutch plate fixed to the second side gear, wherein the fourth washer clutch plate is an outboard washer clutch plate and, during operation of the limited slip differential under differential output when the side gears are rotating relative to each other, the fourth washer clutch plate is forced against adjacent structure of the differential creating frictional drag.

6. The differential as set forth in claim 5, wherein the second and third washer clutch plates are forced against each other primarily during forward operation of the differential due to reaction torque forcing the side gears towards each other, and wherein the first and fourth washer clutch plates are forced against the differential gear case primarily during reverse operation of the differential due to reaction torque forcing the side gears away from each other

7. The differential as set forth in claim 1, further comprising a plurality of pinion gears meshed to radially outer sides of the side gears.

8. The differential as set forth in claim 1, wherein the at least one washer clutch plate includes a steel ferrite nitrocarburized washer clutch plate.

9. The differential as set forth in claim 1, wherein the side gears and the at least one washer clutch plate are supported by the differential gear case for limited axial movement relative to each other.

10. The differential as set forth in claim 1, wherein the differential is a helical gear type limited slip differential.

11. A limited slip differential comprising:
a differential gear case;
first and second side gears supported for rotation relative to the differential gear case;
a first washer clutch plate fixed to the first side gear; and
a second washer clutch plate fixed to the differential gear case;
wherein, during operation of the limited slip differential under differential output when the side gears are rotating relative to the differential gear case, the first washer clutch plate and the second washer clutch plate are forced together creating frictional drag.

12. The differential as set forth in claim 11, wherein the first washer clutch plate is an inboard washer clutch plate splined to an axially inner side of the first side gear and the second washer plate is an inboard washer plate splined to the differential gear case.

13. The differential as set forth in claim 11, wherein the first washer clutch plate is an outboard washer clutch plate splined to an axially outer side of the first side gear and the second washer plate is an outboard washer plate splined to the differential gear case.

14. The differential as set forth in claim 13, further comprising a plurality of inboard washer plates between the first and second side gears, wherein the inboard washer clutch plates include at least one washer clutch plate fixed to one of the side gears and at least one washer plate fixed to the differential gear case, wherein, during operation of the differential under differential output when the side gears are rotating relative to each other, the inboard washer clutch plates are forced together creating frictional drag.

15. The differential as set forth in claim 14, wherein the inboard washer clutch plates are forced together primarily during forward operation of the differential due to reaction torque forcing the side gears towards each other, and wherein the outboard clutch plates are forced together primarily during reverse operation of the differential due to reaction torque forcing the side gears away from each other.

16. The differential as set forth in claim 11, further comprising a plurality of pinion gears meshed to radially outer sides of the side gears.

17. The differential as set forth in claim 11, wherein the first and second washer clutch plates comprise steel ferrite nitrocarburized washer clutch plates.

18. The differential as set forth in claim 11, wherein the side gears are supported by the differential gear case for limited axial movement relative to each other.

19. The differential as set forth in claim 11, wherein the limited slip differential is a helical gear type limited slip differential.

20. A limited slip differential comprising:
a differential gear case;
first and second side gears supported for rotation relative to the differential gear case;
a plurality of pinion gears meshed to radially outer sides of the side gears;
two pairs of outboard washer clutch, each pair of outboard washer clutch plates on a respective axially outer side of a respective side gear and including a first washer clutch plated fixed to the respective side gear and a second washer clutch plate fixed to the differential gear housing; and
two pairs of inboard washer clutch plates, each pair of inboard washer clutch plates including a first washer clutch plated fixed to a respective axially inner side of a respective side gear and a second washer clutch plate fixed to the differential gear housing;
wherein the inboard washer clutch plates are forced together primarily during forward operation of the differential due to reaction torque forcing the side gears towards each other, and wherein the outboard clutch plates are forced together primarily during reverse operation of the differential due to reaction torque forcing the side gears away from each other.
